(19) United States
(12) Patent Application Publication
(10) Pub. No.: US 2005/0024274 A1
(43) Pub. Date: Feb. 3, 2005

(54) Internal antenna device for portable wireless terminal

(75) Inventors: Joo-Ho Byun, Suwon-si (KR); Seon-Kyeng Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/822,105

(22) Filed: Apr. 9, 2004

(30) Foreign Application Priority Data
Jul. 29, 2003 (KR) 52200/2003

(51) Int. Cl. H01Q 1/24

(52) U.S. Cl. 343/702; 343/841; 343/846

(57) ABSTRACT

Disclosed herein is an internal antenna device of a portable wireless terminal, which comprises a shield plate, an antenna plate, and a carrier interposed between the shield plate and the antenna plate. The shield plate is connected to a ground provided at a certain region of an inner surface portion inside the portable wireless terminal. The ground is coated with a conductive material. The antenna plate is positioned adjacent to the inner surface portion of the portable wireless terminal to face the shield plate at a distance. Since the internal antenna device of the portable wireless terminal is constructed to have a single module form, it can be easily manufactured and assembled to the portable wireless terminal. Further, the shield plate has several advantages in that it can minimize interference between the antenna plate and circuit devices provided in the portable wireless terminal, and that it can expand the ground formed inside the portable wireless terminal, thereby enabling the internal antenna device to be used even in a low frequency band.

### PRIORITY

This application claims priority to an application entitled “INTERNAL ANTENNA DEVICE FOR PORTABLE WIRELESS TERMINAL”, filed in the Korean Industrial Property Office on Jul. 29, 2003 and assigned Ser. No. 2003-52200, the contents of which are hereby incorporated by reference.

### BACKGROUND OF THE INVENTION

1. Field of the Invention

The present invention relates to a portable wireless terminal, and more particularly to an antenna device for a portable wireless terminal.

2. Description of the Related Art

Generally, “portable wireless terminals” means devices that are portable and enable owners of the devices to communicate in a wireless fashion. Such portable wireless terminals tend to be much leaner and lighter to facilitate the portability thereof, and their functions have been rapidly diversified so as to adapt to various multimedia environments or internet environments. Currently, the portable wireless terminals are communication devices being generalized without distinction of the user's age or sex, or time and place of use, and are rapidly becoming necessities of modern life.

On the basis of their forms, for example, conventional portable wireless terminals may be classified into a bar-type wireless terminal, a flip-type wireless terminal, and a folder-type wireless terminal. The bar-type wireless terminal comprises a single housing, the flip-type wireless terminal comprises a bar-type housing and a flip part pivotably attached to the housing, and the folder-type wireless terminal comprises a bar-type housing and a folder part pivotably attached to the housing in a foldable manner.

Further, on the basis of the manner or positions in which they are worn, the portable wireless terminals may be classified into types including a neck wearable type terminal configured to be worn around the user's neck using a lanyard, and a wrist wearable type terminal configured to be worn on the user's wrist.

Furthermore, on the basis of their opening/closing manners, the portable wireless terminals may be classified into a rotation type wireless terminal, and a sliding type wireless terminal. In case of the rotation type wireless terminal, its two housings are rotatably connected to be opened away from or closed to each other in a state wherein their facing surfaces are in contact with each other. In case of the sliding-type wireless terminal, its two housings are opened away from or closed to each other by their longitudinal sliding movements allowing the facing surfaces to contact each other.

Those skilled in the art will appreciate the various portable wireless terminals classifications as mentioned above.

The various portable wireless terminals commonly have an antenna device, in order to secure a high transmitting and receiving rate and a good signal quality.

Conventionally, such an antenna device of a portable wireless terminal comprises a helical antenna installed inside an antenna housing provided at the upper end of the portable wireless terminal, and a whip antenna extendible or retractable toward or away from the upper end of the portable wireless terminal through the antenna housing. As an alternative, the antenna housing installed therein with the helical antenna is positioned at one end of the whip antenna so as to be extended or retracted along with the whip antenna according to extension/retraction operations of the whip antenna. The conventional antenna device of a portable wireless terminal is disclosed in U.S. patent application Ser. No. 10/291,144, published May 15, 2003 as Publication No. 20030092415, the disclosure of which is incorporated herein by reference. As described in the above application, the antenna device of a portable wireless terminal is configured in two different fashions such that the antenna housing installed therein with the helical antenna is positioned at the upper end of the portable wireless terminal, and that, in order to prevent damage to the antenna housing protruding out of the portable wireless terminal, the helical antenna is positioned inside the portable wireless terminal.

The conventional antenna device having the whip antenna extendible or retractable toward or away from the upper end of the portable wireless terminal, however, has a problem in that it is easily broken because it protrudes out of the portable wireless terminal. In order to overcome this problem, U.S. Pat. No. 6,577,280, the disclosure of which is incorporated herein by reference, discloses an internal antenna device of a folder-type portable wireless terminal. The disclosed internal antenna device is installed along the inner side edge of a folder part provided in the portable wireless terminal.

In order to enable a portable wireless terminal having an existing internal antenna device to effectively function even at a low frequency, a desired length of the antenna device has to be secured. For this reason, the internal antenna device has been installed only in a bar-type portable wireless terminal having a relatively long length. Therefore, particularly in case of a folder-type portable wireless terminals and miniaturized terminals, there is difficulty in securing the desired length, compared with the bar-type portable wireless terminal, and it is not suitable to mount the internal antenna device due to its poor capability in a low frequency band.

The conventional internal antenna device has a further problem in that the capability thereof deteriorates due to interference caused by the action of surrounding conductors, circuit devices, or the like. Although a separate shield structure is provided in the antenna device in order to cut off interference between the antenna device and surrounding conductors or circuit devices, there remains a problem in that electrical stability and structural reliability of the shield structure is difficult to secure.

### SUMMARY OF THE INVENTION

Therefore, the present invention has been made in view of the above problems, and it is an object of the present invention to provide an internal antenna device of a portable wireless terminal that is configured to reduce interference between the antenna device and surrounding conductors or circuit devices provided in the portable wireless terminal.

It is another object of the present invention to provide an internal antenna device of a portable wireless terminal that improves capability by eliminating interference between the antenna device and surrounding conductors or circuit devices provided in the portable wireless terminal.

In accordance with one aspect of the present invention, the above and other objects can be accomplished by the provision of an internal antenna device of a portable wireless terminal comprising an internal antenna device of a portable wireless terminal comprising a shield plate connected to a ground provided at a certain region of an inner surface portion inside the portable wireless terminal, the ground being coated with conductive materials; an antenna plate positioned adjacent to the inner surface portion of the portable wireless terminal to face the shield plate at a distance; and a carrier interposed between the shield plate and the antenna plate.

In accordance with another aspect of the present invention, there is provided an antenna device of a portable wireless terminal comprising an antenna device receiving recess defined at a certain position of an inner surface portion inside a rear case of the portable wireless terminal to have a certain depth; a ground formed by coating conductive materials on a certain region of the inner surface portion inside the rear case adjacent to the antenna device receiving recess; a shield plate installed on the antenna device receiving recess so as to be connected to the ground; an antenna plate installed in the antenna device receiving recess to face the shield plate at a distance; and a carrier interposed between the shield plate and the antenna plate.

### BRIEF DESCRIPTION OF THE DRAWINGS

The above and other objects, features and other advantages of the present invention will be more fully understood from the following detailed description taken in conjunction with the accompanying drawings, in which:

FIG. 1 is a perspective view illustrating a portable wireless terminal having an internal antenna device in accordance with a preferred embodiment of the present invention;

FIG. 2 is an exploded perspective view illustrating the internal antenna device of the portable wireless terminal shown in FIG. 1; and

FIG. 3 is an exploded perspective view illustrating a coupling manner of the internal antenna device to the portable wireless terminal shown in FIG. 1.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear. Also, the terms used in the following description are terms defined taking into consideration the functions obtained in accordance with the present invention. The definitions of these terms should be determined based on the entire content of this specification, recognizing that such definitions may vary in accordance with the understanding of one of skill in the art.

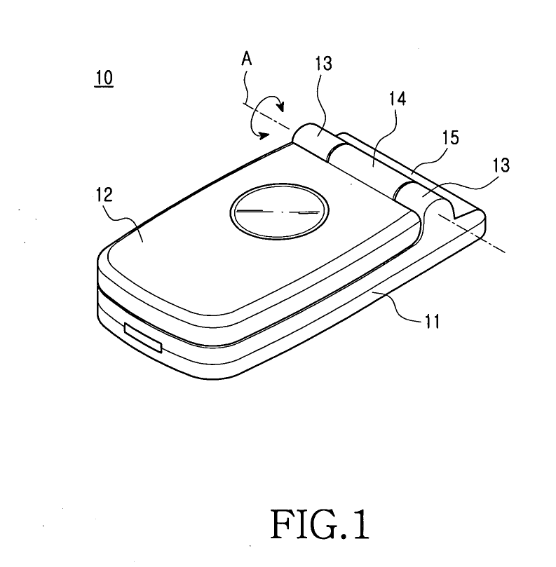

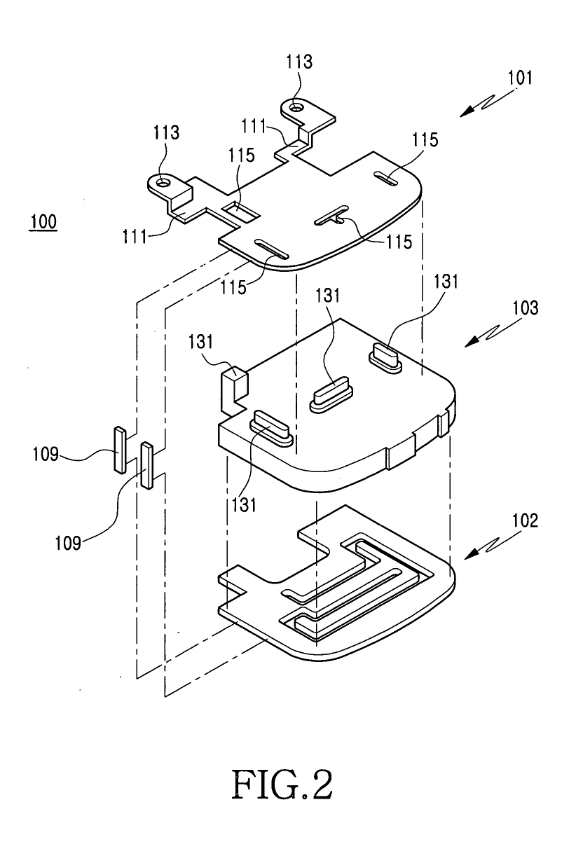

FIG. 1 is a perspective view illustrating a portable wireless terminal 10 having an internal antenna device, designated as reference numeral 100 (see FIG. 2), in accordance with a preferred embodiment of the present invention. As shown in FIG. 1, which depicts a folder type terminal merely for purposes of this description, the portable wireless terminal 10 comprises a main housing 11, and a sub-housing 12 rotatably coupled to the main housing 11. The main housing 11 has a pair of side hinge arms 13 arranged at certain positions of the upper end to face each other at a distance, and an antenna housing 15 extending upward beyond the side hinge arms 13. The sub-housing 12 is provided at the upper end thereof with a center hinge arm 14, which is configured to be interposed between the side hinge arms 13 of the main housing 11. By virtue of the center hinge arm 14, the sub-housing 12 is rotatable toward or away from the main housing 11 about a rotation axis A extending in a transverse direction to the main housing 11, in a state wherein their facing surfaces contact each other when the terminal is in a closed state.

FIG. 2 is an exploded perspective view illustrating the internal antenna device 100 of the portable wireless terminal 10 shown in FIG. 1. As shown in FIG. 2, the internal antenna device 100 according to the preferred embodiment of the present invention comprises a shield plate 101, an antenna plate 102, and a carrier 103.

The shield plate 101, made of conductive materials, serves to cut off electrical interference between the antenna plate 102 and conductors or circuit devices (not shown) provided in the portable wireless terminal 10. The shield plate 101 is provided with one or more fastening pieces 111 The shield plate 101, shown in FIG. 2, has a pair of the fastening pieces 111, each being formed at one end thereof with a fastening hole 113.

The antenna plate 102 acts as a radiation device for performing transmitting and receiving functions of the portable wireless terminal 10. For optimizing radiation capability thereof, the antenna plate 102 can be formed with a certain pattern. The antenna plate 102 is electrically connected with the shield plate 101 through a pair of conductors 109. The conductors 109 orthogonally extend from one side edge of the shield plate 101, and the antenna plate 102 orthogonally extends from the ends of the conductors 109 opposite to the shield plate 101 so as to face the shield plate 101 at a predetermined distance. In other words, the conductors 109 extend in one direction from the shield plate 101 by a certain length, and the antenna plate 102 extends from the opposite ends of the conductors 109 so as to face the shield plate 101 at the predetermined distance.

In this case, the conductors 109 can be bonded to both the shield plate 101 and the antenna plate 102 by welding, soldering, and the like, or integrally formed with both the shield plate 101 and the antenna plate 102. The conductors 109 serve to electrically connect a ground provided on the antenna plate 102 to the shield plate 101. As stated above, since the shield plate 101, antenna plate 102 and conductors 109 can be integrally formed with one another, the internal antenna device 100 of the present invention can be easily manufactured and simply assembled on the portable wireless terminal 10.

The carrier 103 is made of insulating materials and is interposed between the shield plate 101 and the antenna plate 102. For the coupling of the carrier 103, the shield plate 101 can be formed with coupling slots 115, and the carrier 103 can be formed with coupling protrusions 131 at one surface thereof facing the shield plate 101. The coupling protrusions 131 correspond to the coupling slots 115, respectively. The antenna plate 102 is attached to the other surface of the carrier 103. It should be understood that the coupling between the shield plate 101 and carrier 103 or between the carrier 103 and antenna plate 102 can be achieved through various coupling methods including screw fastening and adhesion methods.

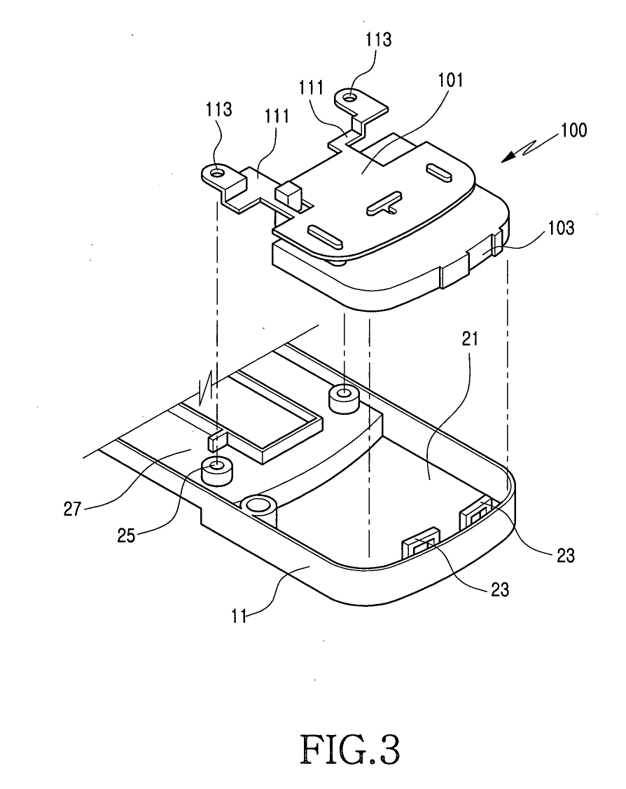

Referring to FIG. 3 illustrating a rear case of the main housing 11 provided in the portable wireless terminal 10, the internal antenna device 100 constructed as stated above is fitted in an antenna device receiving recess 21, which is defined in the rear case of the main housing 11 to have a certain depth. In addition to the antenna device receiving recess 21, the main housing 11 comprises one or more snap-fitting hooks 23 at the upper end thereof, and boss-shaped holes 25 formed adjacent to the antenna device receiving recess 21 so as to correspond to the fastening holes 113 of the shield plate 101, respectively.

Those skilled in the art will easily appreciate that the snap-fitting hooks 23 are means for coupling the rear case of the main housing 11 with a front case (not shown). Since the antenna device receiving recess 21 has a profile corresponding to that of the internal antenna device 100, the antenna device 100 can be assembled in the portable wireless terminal 10 by being simply positioned in the antenna device receiving recess 21. After the fastening holes 113 of the shield plate 101 and the boss-shaped holes 25 of the main housing 11 are aligned; certain fastening means such as screws are penetrated therethrough to secure the internal antenna device.

As stated above, thanks to the fact that it is manufactured as a single module, the assembly work of the internal antenna device 100 can be easily performed merely by positioning it in the antenna device receiving recess 21. Furthermore, thanks to fastening the screws, structural stability as well as reliability of products can be improved. Meanwhile, certain boss-shaped holes are provided at the main housing 11 for coupling the rear and front cases thereof. They can be used as the boss-shaped holes 25 by itself or after being appropriately displaced. Therefore, it is not necessary to form additional boss-shaped holes for the coupling of the shield plate 101.

The main housing 11 is provided at an inner surface portion 27 adjacent to the antenna device receiving recess 21 with a ground, which is coated with a conductive material, and the like. The boss-shaped holes 25 are formed on the ground. In this state, the shield plate 101 is connected to the ground provided at the inner surface portion 27 of the main housing 11 by means of the boss-shaped holes 25 and fastening pieces 111. Such connection of the shield plate 101 to the ground results in a ground expansion effect. As the ground of the main housing 11 is expanded by the shield plate 101, it is possible to improve the capability of the antenna device 10 in a general wireless frequency band, especially, in a low frequency band such as CDMA, GSM, and the like. As described above in regard to the related art, conventional internal antenna devices are difficult to utilize in low frequency bands, such as CDMA, GSM, and the like. In contrast, in the case of the internal antenna device 10 having the shield plate 101 according to the present invention, the bandwidth of the antenna device 10 is expanded by about 30%, thereby enabling the antenna device 10 to be used even in the low frequency band of 824 to 849 MHz (Tx bandwidth) of the CDMA frequency band.

Where the internal antenna device 100 is mounted in the portable wireless terminal 10 in such a fashion that the antenna plate 102 is disposed to face the rear surface of the portable wireless terminal 10, and the shield plate 101 is interposed between the front surface of the portable wireless terminal 10 and the antenna plate 102, the shield plate 101 serves to cut off electric waves radiated toward the human body from the antenna plate 120, thereby improving a specific absorption ratio (SAR). Practically, it was observed that the specific absorption ratio is reduced from 2.2 mW/g to 1.0 mW/g according to the installation of the shield plate 101.

As apparent from the above description, according to the present invention, an internal antenna device of a portable wireless terminal is configured so that a shield plate, an antenna plate and a carrier interposed between the shield plate and the antenna plate form a single module, and that the antenna plate and the shield plate are integrally manufactured, thereby enabling the internal antenna device to be easily manufactured and assembled With the portable wireless terminal. Further, the shield plate has an advantage in that it can improve a specific absorption ratio while minimizing interference between the antenna plate and other circuit devices. Furthermore, as the shield plate actually expands a ground provided in the portable wireless terminal, the internal antenna device can be used even in a low frequency band.

Those of skill in the art will recognize that the present invention, though described above as being applied to a folder-type type, can readily be applied to other types of portable wireless terminals.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An internal antenna device of a portable wireless terminal comprising:
a shield plate connected to a ground provided on an inner surface portion of the portable wireless terminal, the ground being coated with conductive material;
an antenna plate positioned adjacent to the inner surface portion of the portable wireless terminal, facing the shield plate at a predetermined distance; and
a carrier interposed between the shield plate and the antenna plate.

2. The device as set forth in claim 1, wherein the shield plate is made of conductive material, and comprises one or more fastening pieces, and fastening holes formed at ends of the fastening pieces, respectively,
wherein the fastening pieces are connected to the ground.

3. The device as set forth in claim 2, further comprising boss-shaped holes formed on the ground provided at the inner surface portion of the portable wireless terminal,
wherein the fastening pieces of the shield plate engage the boss-shaped holes.

4. The device as set forth in claim 1, further comprising a conductor, wherein the antenna plate is integrally formed at one end of the conductor, which extends from one side edge of the shield plate and is perpendicular thereto.

5. The device as set forth in claim 1, wherein the antenna plate is electrically connected with the shield plate through a conductor.

6. The device as set forth in claim 1, wherein the carrier is made of an insulating material.

7. The device as set fourth in claim 1, wherein the antenna plate improves a specific absorption ratio during operation of the portable wireless terminal.

8. An antenna device of a portable wireless terminal comprising:
an antenna device receiving recess defined on an inner surface portion inside a rear case of the portable wireless terminal and having a certain depth;
a ground formed by coating a conductive material on the inner surface portion of the rear case adjacent to the antenna device receiving recess;
a shield plate installed in the antenna device receiving recess so as to be connected to the ground;
an antenna plate installed in the antenna device receiving recess, facing the shield plate at a predetermined distance; and
a carrier interposed between the shield plate and the antenna plate.

9. The device as set forth in claim 8, further comprising:
boss-shaped holes formed on the ground; and
fastening pieces formed on and extending from the shield plate so as to engage the boss-shaped holes.

10. The device as set forth in claim 8, wherein the antenna plate is electrically connected with the shield plate through a conductor.

11. The device as set forth in claim 8, further comprising a conductor extending from one side edge of the shield plate and perpendicular thereto,
wherein the antenna plate extends from one end of the conductor perpendicular thereto so as to face the shield plate at the predetermined distance.

12. The device as set forth in claim 11, wherein the shield plate, the conductors and the antenna plate are integrally constructed.

13. The device as set forth in claim 8, wherein the antenna plate improves a specific absorption ratio during operation of the portable wireless terminal.
